(19) United States
(12) Patent Application Publication
(10) Pub. No.: US 2020/0317332 A1
(43) Pub. Date: Oct. 8, 2020

(54) TANDEM WING TAIL-SITTING AIRCRAFT WITH TILTING BODY

(71) Applicant: NEOPTERA LTD, Portsmouth (GB)

(72) Inventor: Arnaud Didey, Portsmouth (GB)

(73) Assignee: NEOPTERA LTD, Portsmouth (GB)

(21) Appl. No.: 16/956,658

(22) PCT Filed: Dec. 21, 2018
(86) PCT No.: PCT/GB2018/053752

§ 371 Date: Jun. 22, 2020

(30) Foreign Application Priority Data
Dec. 22, 2017 (GB) 17218371
Dec. 18, 2018 (GB) 18170027

(51) Int. Cl. B64C 29/02; B64C 39/08

(52) U.S. Cl. CPC B64C 29/02; B64C 39/08

(57) ABSTRACT

The present invention provides an aircraft described as an Airborne Urban Mobility Vehicle with VTOL (Vertical Take-Off and Landing) capability. The aircraft has a 5 fuselage freely pivoted between lateral arms of a yoke; the arms of the yoke extending fore and aft and, at or towards the extremities of the arms: the respective fore portions are linked laterally together by an aerofoil; and the respective aft portions are linked laterally together by an aerofoil; and at least one of the fore and aft aerofoils having mounted thereon one or more propulsion units.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### STATEMENT OF RELATED APPLICATIONS

The present application claims the benefit of International Application PCT/GB2018/053752 filed Dec. 21, 2018. The application is entitled “A Tandem Wing Tail-Sitting Aircraft with Tilting Body.”

The international application claimed the benefit of GB 1721837.1 filed Dec. 22, 2017 and GB 1817002.7 filed Oct. 18, 2018. Each of those applications is also entitled “A Tandem Wing Tail-Sitting Aircraft with Tilting Body.”

Each of these applications is incorporated herein by reference in its entirety.

### BACKGROUND OF THE INVENTION

This section is intended to introduce selected aspects of the art, which may be associated with various embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present invention relates to an A-UMV (Airborne Urban Mobility Vehicle) with VTOL (Vertical Take-Off and Landing) capability. A-UMV is a development of the macro copter and drone concepts but scaled up so as to potentially carry a person or at least a more significant payload.

### DISCUSSION OF TECHNOLOGY

The term A-UMV is used to describe an airborne vehicle designed to enhance mobility in and around congested cities and metropolises, avoiding traffic jams (typically above-ground) or overcrowded public transportation systems (under and above-ground).

A-UMV available to travellers are currently essentially limited to helicopter typically used within large cities equipped for example with roof-tops landing pads. Helicopters are however very expensive to procure and maintain, noisy, bulky and on the whole reliant on non-renewable fuel, contributing to further emissions in already heavily polluted cities.

It is anticipated that the use of electric A-UMV will expand dramatically as congestion on roads in and around cities result in ever increasing commute/journey time. The business case for such future mode of transport is comprehensively discussed in UBER Elevate in what UBER refers to as on-demand aviation.

This future will only be made possible with the evolution of infrastructures, regulations and technologies. In particular, amongst key enablers of electric A-UMV are electric propulsion systems and in particular the batteries and charging technologies required to store electrical energy and top-up between flights. In addition, to ensure that A-UMV can be safely accessed to as many users as possible, sophisticated flight control algorithms will have to be developed to assist users/riders in piloting such aircraft before eventually enabling autonomous flight.

Whilst the above infrastructure is essential there is also requirement to provide an efficient A-UMV concept which optimises the use of electric propulsion and can negotiate a crowded urban environment.

### Known and Proposed A-UMV Systems

A number of novel electric A-UMV concepts are also currently under development, in an effort to negate the drawbacks of helicopters (complexity, noise, pollution, cost). Two different types of A-UMV are being developed, wingless multi-rotor VTOL rotorcrafts and winged VTOL aircraft/airplanes:

### Wingless Multi-Rotors

Representative wingless multi-rotor UMV's, are those developed by the Chinese company eHang, the German company Volocopter or Airbus concept developed by ltalDesign.

The eHang concept provides a central fuselage, on an effectively rectangular base, with arms protruding from the vertices of that base, the arms terminating in double sided propeller arrangements. The Volocopter 2X concept provides a central helicopter like fuselage but in place of the helicopter rotor a network of beams supports a plurality, around 18 electrically driven propellers. The ltalDesign concept provides a central helicopter like fuselage above which for arms protrude, the arms terminating in ducted propellers.

These are essentially electric multi-rotor helicopters benefiting from the simplicity afforded by distributed fixed-pitch propellers. Such wingless aircraft are ideally suited to vertical take-off and landing by design. However, they are essentially helicopters having a plurality of rotors in the form of fixed pitch propellers. As such, their reliance on rotary wings results in significant power consumption during level flight compared with aircraft equipped with fixed wings. In the context of electrically powered multi-rotor wingless UMV (and due to the limitations of existing battery technology), this dramatically reduces the speed, range and endurance of multi-rotor wingless UMV and limits them to relatively short journeys between battery re-charge or replacement.

### Winged VTOL (Vertical Take-Off and Landing) Aircraft/Aeroplane

In contrast to the helicopter concept the aeroplane approach is to a powered heavier-than-air aircraft with fixed wings from which it derives most of its lift, at least during the main horizontal transport phase of flight. This allows for rapid forward motion and relatively higher energy efficiency, for example as evidenced by a higher lift to drag ratio, typically greater than 10. The lift to drag ratio for a helicopter as such is lower than 5 and the lift to drag ratio for a fixed pitch multirotor helicopter is typically lower than 2. The VTOL concept providing an initial vertical transport phase in flight to avoid the use of runways and therefore conform to the requirements of urban transport. A number of VTOL aircraft have been developed over the years, mainly for military applications, such as the Boeing V-22 Osprey, the Ling-Temco-Vought XC-142 or the Harrier Jump Jet.

In terms of A-UMV VTOL exemplary current concepts are the Lillium, AeorospaceX Mobi and Airbus Vahana, which like wingless multi-rotor have the ability to take-off and land vertically from small foot-print urban landing pads but additionally comprise wings to give lift during horizontal movement. The Lillium concept provides a conventional fuselage with fixed wings but upon the fixed wings are a plurality of rotatable ducted fans which are rotatable between horizontal and vertical orientation, this is supplemented by further ducted fans protruding from the nose region of the aeroplane for giving additional, balancing, vertical lift during take-off. The Vahana concept provides a fuselage with fore and aft aerofoils on which are mounted a plurality of propellers, each aerofoil being rotatable relative to the fuselage to orientate the propellers vertically or horizontally depending on the flight mode.

However, winged VTOL aircraft also have the ability to transition from vertical to level flight and rely on fixed wings to dramatically improve level flight efficiency reducing power consumption and increasing speed, range and endurance. As a result, particularly in the context of battery powered aircraft, winged VTOL electric UMV are anticipated to offer a more viable alternative to wingless electric Multi-rotors for urban transportation over larger distances and/or operate for longer between batteries re-charge or replacement;

The main drawback of winged VTOL electric A-UMV over their wingless Multirotor counterparts is the potential complexity of the mechanism(s) required to transition from vertical to level flight and the safety implications associated with a possible failure of such mechanism during a transition.

In summary, the wingless helicopter type aircraft whilst highly manoeuvrable are energy intensive and have limitations in terms of forward flight velocity and range. The winged VTOL aircraft overcome this limitation by transitioning to a different geometry for horizontal flight but at the cost of considerable additional complexity. This reduces the potential reliability of the aeroplanes, at the least increases the cost and complexity of maintenance and produces increased regulatory hurdles to get the designs approved.

There is therefore a need to provide an A-UMV which develops the concept of the micro/drone 15 aircraft not only in the use of predominantly electric propulsion was also in the simplicity and potential for mass production, this as opposed to the traditional aircraft development route in a scaled-down format with intrinsic complexity remains, which gives rise to the costs of developing miniaturisation as well as the requirements for sophisticated maintenance.

In addition, all of the above VTOL aircraft whether having reached production or simply concept stage have, many moving parts which are required to move so as to transition from vertical to horizontal flight mode, should any one part failed to transition in synchronisation or simply completely fail to transition then the airworthiness of the aircraft would be severely compromised. There is therefore a need for a winged A-UMV VTOL capable aircraft of reduced complexity and implied reliability. There is also a need for a winged A-UMV VTOL capable aircraft capable of failing safe should a transition between horizontal and vertical flight malfunction.

### BRIEF SUMMARY OF THE INVENTION

The present invention provides a tandem wing aircraft capable of vertical take-off and landing; the aircraft comprising:
a fuselage pivoted between lateral arms of a yoke;
the arms of the yoke extending fore and aft and, at or towards the extremities of the arms:
the respective fore portions are linked laterally together by an aerofoil being a first of the tandem wings; and
the respective aft portions are linked laterally together by an aerofoil being the second of the tandem wings;
and at least one of the fore and aft aerofoils having mounted thereon one or more propulsion units.

The present invention in its various aspects is as set out in the appended claims.

### Tandem Wing Aircraft

A tandem wing aircraft has two wings. The wings are staggered that is one wing, the first aerofoil, is located fore of the other, second, aerofoil which is aft of the first aerofoil, when viewing the aircraft in its horizontal flight configuration. For the present invention this means that the trailing edge of the fore aerofoil is ahead of and does not overlap the leading edge of the aft aerofoil. The wings of the present invention may be described as significant stagger, that is they do not overlap horizontally in the horizontal flight configuration.

Fore and aft refer to the front and rear potions of the aircraft in its horizontal flight configuration.

The wings are preferably positioned fore and aft of the fuselage when viewing the aircraft in its horizontal flight configuration. By being positioned fore and aft of the fuselage the leading edge of the fore, or leading wing (the first aerofoil), is ahead of the nose of the fuselage and the trailing edge of the aft or trailing wing (the second aerofoil) is behind the tail of the fuselage.

Preferably by being positioned fore and aft of the fuselage the trailing edge of the leading wing is ahead of the nose of the fuselage and the leading edge of the aft or trailing wing is behind the tail of the fuselage. The benefit of the greater separation is to ensure that the fuselage can be rotated throughout its range of motion, between a vertical flight configuration and a horizontal flight configuration without interfering with the wings, in particular without any interference between the nose of the fuselage and the trailing edge of the leading wing.

If the horizontal separation (when viewing the aircraft in horizontal configuration) between the wings was insufficient for the fuselage to rotate without interference, then the vertical separation (when viewing the aircraft in horizontal configuration) would have to be significantly greater to allow for the fuselage rotation. This would mean that the foot-print of the aircraft (when viewing the aircraft in vertical configuration) would be significantly larger and would require larger take-off and landing infrastructures and larger storage facilities to accommodate aircraft during down-time such as night time or in the event of adverse weather conditions that would prevent flights.

The staggered and offset wing configuration of the present invention, confer the aircraft with a significantly reduced foot-print (<50%) than a similar aircraft with a co-planar wing arrangement.

Another benefit of the greater wing separation is to limit the airflow interactions between the staggered and offset wings and improve the aerodynamic efficiency of the aircraft.

A horizontal flight configuration is when the cords of the wings are parallel or substantially parallel to the ground in flight. If the cords of the wings are not parallel the fore wing is the wing by which horizontal flight configuration is to be judged.

As stated, tandem wing aircraft has two wings. The wings may be offset. That is one wing, the first aerofoil, is located above or below of the other, second, aerofoil which is correspondingly below or above the first aerofoil, when viewing the aircraft in its horizontal flight configuration. For the present invention this means that the top of the fore aerofoil at its maximum thickness and its highest point is below the bottom of the aft aerofoil at its maximum thickness and its lowest point (so located below) or that the top of the aft aerofoil at its maximum thickness and its highest point is below the bottom of the bottom of the fore aerofoil at its maximum thickness and its lowest point (so located above).

The preferred offset of a four passenger version of the present invention is of the order of 4 to 5 metres to be compared to a wing span of the order of 8 to 10 metres.

The fore (first) aerofoil is preferably below the aft (second) aerofoil in the horizontal flight configuration. This provides a clearer view for the pilot. Similarly, by raising the first (fore) wing significantly above the ground and therefore significantly above the pod, the present invention confers to the pilot improved visibility during vertical flight phase, visibility that is crucial in this phase of the flight to the safety of aircraft and its occupants. In prior inventions US 2014/0097290, US 2011/0042509 or US 2018/0093765, pilot visibility is impaired by the presence of the co-planar first wing, in front of the fuselage cockpit. However, as the present invention is VTOL the presence of an aerofoil in the line of sight between a pilot and a runway is less of an issue as the vertical landing places the fore aerofoil above the pilot's head and gives a large unobstructed view for landing.

When using co-planar or quasi co-planar (i.e. overlapping stacked) wings, carefully positioning the centre of mass of the aircraft relative to its aerodynamic centre would become problematic without translating the body/fuselage horizontally to accommodate variations of its centre of mass resulting from an uneven distribution of the aircraft payload, such as an under occupied aircraft, for example only 3 passengers in a 5 seat aircraft, or uneven distribution of passenger mass, for example children seating in some seats and adults in other seats, or an uneven distribution of the aircraft cargo, in the cargo hold.

Unlike a biplane (or its equivalents with a multiplicity of stacked wings), the tandem wing aircraft of the present invention does not require a dedicated horizontal stabiliser and/or vertical stabiliser, such as a tail or tail plane, for stable flight. This type of aircraft features a set of staggered and offset wings also known as tandem wings. The staggered and offset tandem wings are positioned fore and aft of the fuselage when viewing the aircraft in its horizontal flight configuration.

A tail plane, such as a horizontal stabiliser vertical stabiliser combination is a structure typically at the rear of an aircraft that provides stability and control during flight and does not provide significant lift.

The tandem wing aircraft of the present invention preferably does not have a tail plane. Unlike bi-plane with their co-planar or overlapping stacked wing arrangement, the tandem wing aircraft do not require an additional horizontal stabiliser for longitudinal stability, as both wings are significantly offset from one another to ensure that one of the wings, typically the aft wing, acts as the main wing and a fore wing acts to balance the mass moments with aerodynamics moment as is normally the case with a horizontal stabiliser plane. Unlike bi-plane with their co-planar or overlapping stacked wing arrangement, the tandem wing aircraft do not require an additional vertical stabiliser for longitudinal stability, as this function can be assumed by one of the two staggered and offset wings

Preferably, in the tandem (or staggered/offset) wing arrangement of the present invention, the centre of mass of the aircraft is located forward of the aft wing, in between the fore and aft wings when viewing the aircraft in flight horizontal configuration. Not only does this wing arrangement confers the aircraft with acceptable longitudinal stability, it also makes it more tolerant to variations of its centre of mass and therefore a practical solution for the transport of multiple passengers, in particular in cases of under-occupancy or uneven passenger weight or cargo weight distribution.

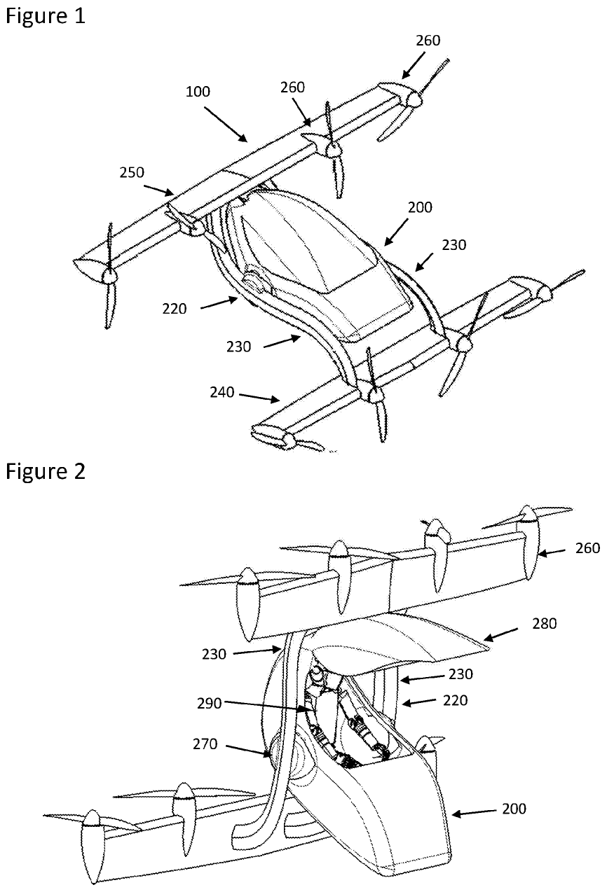

Consequently, when viewing the aircraft in its horizontal position (see FIG. 1), the first wing (also referred to as fore wing) is positioned in front of the pod/fuselage and the second wing (also referred to as aft wing) is positioned behind the pod/fuselage.

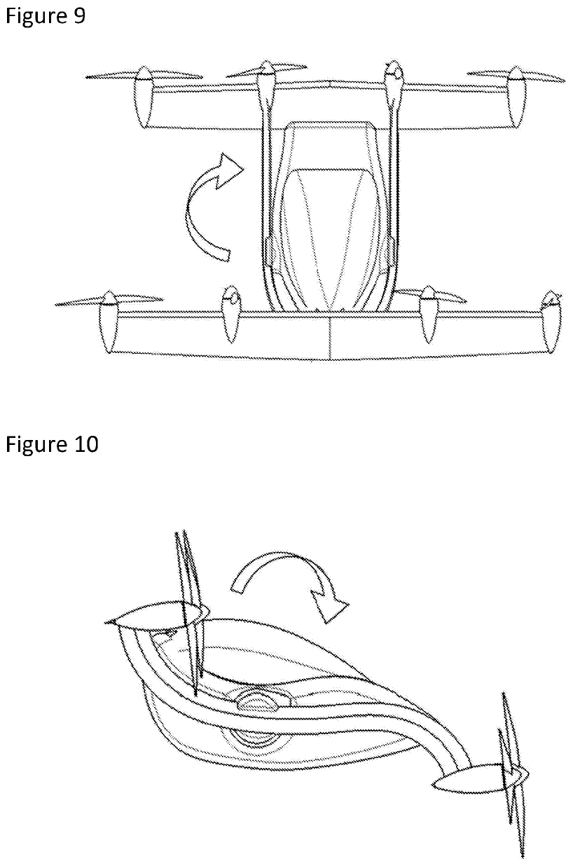

As depicted, in FIG. 9 for example, the first (fore) and second (aft) wings do not necessarily have the same size (span, surface, chord or thickness). In the particular embodiment depicted throughout, it should be noted that the pivot point of the pod/fuselage is biased towards the second (aft) wing when viewing the aircraft in its horizontal configuration, as is depicted in FIG. 9 or FIG. 10.

This is to assist passenger embarkation (as discussed later) but it also shifts the centre of mass of the aircraft to the rear. As a result, and to maintain the centre of mass of the aircraft in front of the aerodynamic centre of the aircraft, the rear wing surface has to be larger than the front wing surface to offset the aerodynamic centre rearward and keep it behind the aircraft centre of mass when viewing the aircraft in its horizontal configuration.

This confer the aircraft with an acceptable longitudinal stability and tolerance to variations in aircraft centre of mass unlike the wing arrangement of prior inventions US 2014/0097290, US 2011/0042509 or US 2018/0093765 or EP 3263445.

In an effort to ease passenger access (in particular without the need for a ladder for example), the pod is located as close to the ground as possible, similarly to EP 3263445. However, with the present invention, this is enabled without the need for an additional mechanism or motion designed to lift/translate the pod in position between the wings as required in EP 3263445. Unlike prior invention EP 3263445 where both co-planar are above the fuselage when in vertical position (see claim 4 and FIG. 4), the staggered and offset wing arrangement means that the second wing (aft of the fuselage) in the present invention is positioned lower than the fuselage when viewing the aircraft in its vertical configuration whereas the first wing (fore of the fuselage) is located above the fuselage. As such, the fuselage and its centre of mass is already located between both wings.

It is important to note that due to the staggered and, optionally, offset wing configuration of the present invention, the fuselage centre of mass is very preferably located between the two wings, both in vertical configuration as mentioned above, and in horizontal configuration.

The features of staggered wings and of offset wings are combinable and the combination of staggered (fore/aft) separation and offset (up/down) wing separation by the first and second aerofoils is particularly preferred as it provides both stable flight, good pilot visibility and, with a suitable support, a VTOL confirmation analogous to tail sitting giving a small footprint and hence landing area combinable with ease of access and egress on the ground.

The present invention is preferably configured in a tail-sitting configuration to facilitate vertical flight from take-off and landing.

A tail-sitter or tail-sitter is a type of VTOL aircraft that takes off and lands on its tail, then tilts horizontally for forward flight.

In the present invention there is preferably not tail as such and hence the term tail-sitting configuration related to the use of a support member suitable for supporting the aircraft in a vertical configuration on the ground, vertical in comparison to the horizontal configuration of horizontal flight. The support member may be a dedicated horizontal stabiliser in addition to the second aerofoil.

In order to alleviate the historical practical limitations of past tail-sitting aircraft, a tilting body is provided to ensure that passengers are always in a level or quasi-level position. As such the pod/fuselage of the present invention features a pivot and preferably a mechanism to control the pivoting motion.

Another category of winged VTOL aircraft, known as Tail-sitters allows for a seamless transition, effected by a forward pitching moment (resulting from differential thrust, differential aero-dynamic moments from control surfaces or a combination of both) without resorting to safety critical mechanisms such as necessary with tilting wings, tilting rotors and similar arrangements.

Tail-sitter aircraft have historically been rather impractical for passengers to embark and disembarks safely when the aircraft is in vertical configuration, and in particular unsafe to evacuate in an emergency. In addition, a conventional tail-sitting configuration limits the visibility of the pilot during vertical flight phases and present a safety hazard to the aircraft and its surroundings. This is overcome by the present invention.

This drawback of tail-sitters has been recognized in prior inventions and in part resolved with the addition of a tilting body, allowing passengers to remain level or quasi-level at all time.

All known prior tilting body inventions such as US 2014/0097290, US 2011/0042509, US 2018/0093765 or EP 3263445, rely on a biplane wing configuration, whereby co-planner or overlapping stacked (overlapping) wings are used. In addition, none of the prior inventions cited above appear to be provisioning for an additional horizontal stabiliser plane, as is required with traditional aeroplanes.

In addition, the present invention, as illustrated throughout, features two staggered and offset wings rather than two co-planar or overlapping stacked wings. When viewing the aircraft in its vertical configuration (see FIG. 2) a first wing is situated above and forward of the pivot point of the pod/fuselage and a second wing is situated behind and below the pivot point of the pod/fuselage.

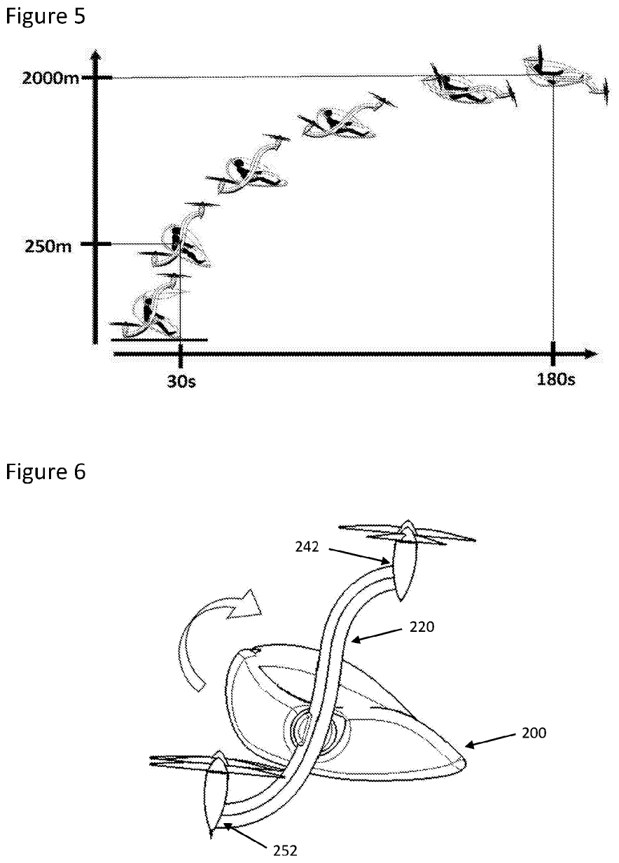

As such, in the event of the failure of the fuselage pivot mechanism that may leave the fuselage in any of the intermediate position depicted in FIG. 5, the aircraft centre of mass remains broadly between the first and second wing, to ensure safe and controllable flight. The use of the fuselage pivot mechanism with its the port and starboard pivots is preferably used to adjust fuselage positioning and so provides a further mechanism to enhance flight stability.

This is not the case with prior invention EP 3263445, where a failure of the fuselage mechanism in any intermediate position as depicted throughout FIG. 40 to FIG. 4P, would result in an aircraft that would become uncontrollable, or an aircraft that would not be capable of landing safely in particular if the mechanism remained blocked in the position suggested in FIG. 40.

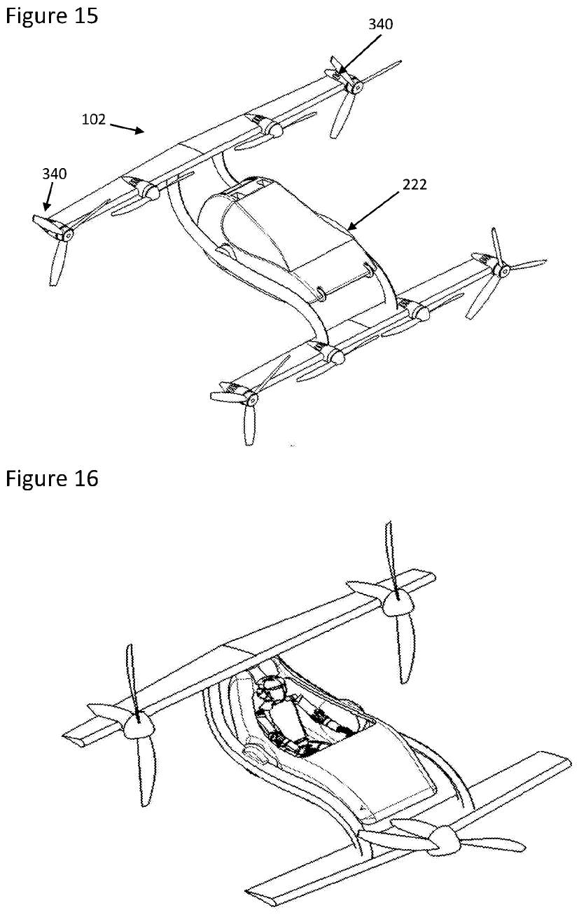

Preferably a plurality of propulsion units distributed along both first/fore and second/aft staggered and offset wings is provided in the present invention, to provide both the redundancy required to tolerate the failure of one or more propulsion units, but also to provide the moments required to control the aircraft in flight using differential thrust and moments as has been researched and publicly documented in particular by NASA in the 1990s, prior to the filing of US 2014/0097290. The use of control surfaces (as depicted in FIG. 14) may be required to assist in controlling the aircraft in flight as is the case with traditional aeroplanes and in particular during the transition from vertical to horizontal flight when the aircraft is control to pitch forward from vertical to horizontal flight.

Another key benefit of the present invention pertains to the safety of passengers during embarkation and disembarkation, and in particular in the event of an emergency evacuation of the aircraft, especially when considering that passengers tend to have impaired judgement following an emergency landing.

This is a key aspect of the certification of civil aviation aircraft. The staggered and offset wing configuration of the present tail-sitting aircraft configuration proposed in the present invention ensures that in its vertical configuration, access to and from the aircraft cabin is taking place from the front of the aircraft and from under the first (fore) wing when viewing the aircraft in its vertical configuration, as suggested in FIG. 20. In a practical application of the proposed invention, designed to carry several passengers the offset between the first and second wings is in excess of the length of the fuselage as evidenced in FIG. 15. As such during ground access to the fuselage cabin, the propulsion units of the first (fore) wing are at a safe distance above any standing human being, keeping passengers out of harm's way in the event of a precipitated evacuation of the cabin when propellers may still be rotating immediately after landing.

It should also be noted that the natural longitudinal stability conferred in flight by the staggered and offset wing arrangement of the present invention also extend to the ground in the event of an emergency horizontal landing that may result from a failure of part or all of the propulsion units and prevent a vertical landing. The significant offset between the first (fore) and second (aft) wing, in excess of the length of the fuselage and of a similar order of magnitude to the wing span of the aircraft would make it more likely for the aircraft would remain up-right and avoid flipping over than a co-planar or overlapping stacked arrangement.

Generally, VTOL aircraft rely on mechanisms to either rotate propellers/thrusters with respect to the aircraft wings (as is the case with Lillium or the Harrier and Osprey) or to rotate the entire wings to which propellers/thrusters are attached (as is the case with the XC-142 or the Vahana concept). This calls for relatively complex and potentially highly loaded mechanisms, due to the sheer thrust of the propulsion but also the gyroscopic effect of the rotating propeller or thruster shaft. This can also present a hazard during the transition from vertical to level flight in the event of a mechanical jam but also result in instability as all the forces involved have to carefully be balanced.

Vertical Take Off and Landing (VTOL) aircraft have the unique ability to take-off and land vertically from virtually anywhere and require minimal infrastructures unlike Conventional Take-Off and Landing (CTOL) aeroplanes that require for example a runway.

Helicopters and other similar wingless aircraft relying solely on rotary wings to generate lift are limited in speed and range, as they require significant power to produce the lift necessary for forward flight.

The addition of wings to provide lift during flight allows for higher speed, reduced power consumption and consequently greater range. This is particularity beneficial in the context of electric propulsion, where battery energy density and power density are currently limited by technology.

Fixed-winged VTOL have historically been relatively dangerous compared with CTOL aircraft and unsuitable for manned commercial transport applications. This is due to the fact that most concepts have relied on mechanisms, prone to critical failures and blockages, to convert from vertical to horizontal flight, such as tilting wings, tilting rotors or vectoring thrust.

Some fixed-wing VTOL concepts such as lift and cruise do not require mechanisms for the transition from vertical flight to horizontal flight and instead rely on dedicated vertically mounted propulsion units for the vertical flight phase and dedicated horizontally mounted propulsion units for the horizontal flight phase.

This is potentially safer and simpler, but the plurality of propulsion units (there is no mutualization of propulsion units) compromises reliability by multiplying active parts and also tend to increase aerodynamic drag during horizontal flight, further limiting speed and range.

Biplane CTOL aircraft have been used in the early days of aviation but as any aircraft they require an horizontal stabiliser plane (typically aft of the main wing and sometimes forward of the main wing, referred to as a canard) positioned far from the main wing surface, in order to balance mass and aerodynamic moments and provide the aircraft with adequate longitudinal stability margins to guarantee a comfortable, controllable and safe flight for commercial passenger transport.

For an aircraft to be sufficiently stable and safe for commercial passenger applications, the centre of mass must ideally be in front of its aerodynamic centre or sufficiently close to allow modern flight computers to stabilize the aircraft on behalf of the pilot.

On a conventional general aviation single or bi-plane aircraft, the centre of mass is in front of the main wing, to ensure longitudinal stability, and a horizontal stabiliser plane is used, typically at the aft extremity of the fuselage to balance with aerodynamic moments the mass moments resulting from the forward centre of mass.

Removing the horizontal stabiliser of a traditional winged aircraft, or the horizontal stabiliser of a bi-plane aircraft, as suggested in US 2014/0097290, US 2011/0042509 or US 2018/0093765 would result in an aircraft highly sensitive to the position of its centre of mass (or centre of gravity).

Although this may be practical when carrying a single passenger that would be carefully seated slightly forward and in between the co-planar or overlapping stacked biplane wing arrangement (when viewing the aircraft in its horizontal configuration), it is unlikely to be a practical solution for the safe transport of multiple passengers, for example 4-5 passengers as is typically the case with general aviation aircraft.

Indeed, when using co-planar or quasi co-planar wings, carefully positioning the centre of mass of the aircraft relative to its aerodynamic centre would become impossible without translating the body/fuselage horizontally to accommodate variations of its centre of mass resulting from an uneven distribution of the aircraft payload, such as an under occupied aircraft, for example only 3 passengers in a 5 seat aircraft, or uneven distribution of passenger mass, for example children seating in some seats and adults in other seats, or an uneven distribution of the aircraft cargo, in the cargo hold.

Another direct consequence of the longitudinal stability issue that results from a tail-less co-planar or overlapping stacked wing arrangement, is that due to the fact that the fuselage and its passengers have to be positioned in close proximity to the wings and therefore propulsion units, in particular propellers. This makes access to the aircraft for the purpose of embarking and disembarking not only impractical for commercial passenger transport but also potentially dangerous and in particular the matter of emergency aircraft evacuation in the event for example of a cabin fire that may result in passenger harm. This may be as a result of a direct hit from a moving propeller and/or the result of the suction caused by a moving ducted or open propulsion units.

All of these limitations are recognized in prior invention EP 3263445 as it suggests that a mechanism is provided to not only tilt the body of the aircraft but also translate the fuselage into a suitable position in between the cop-planar wing arrangement, as discussed in paragraph 47 of EP 3263445.

This translation could be used to accommodate variations of the aircraft centre of mass or the aircraft variations of its aerodynamic centre during flight to confer the aircraft with an acceptable longitudinal stability. However not only does this adds unnecessary complexity to the aircraft, by requiring a mechanism that both rotates and translates, it also adds a failure mechanism that could render the aircraft too unstable to ensure continued safe flight and landing. In the event of a failure of the mechanism during flight, the fuselage may become blocked in any of the intermediate positions depicted throughout FIG. 40 to FIG. 4P and result in an uncontrollable aircraft.

In the present invention the fuselage may be in the form of a pod. A Pod is a detachable or self-contained unit of the aircraft and is preferably has the prime function of carrying a passenger, such as a pilot.

In addition, EP 3263445 calls in claim 4 and depicts in FIG. 4C a wing arrangement such that the co-planar wings are both above the pod/fuselage, presumably for safe and practical access to the fuselage during passenger embarkation and disembarkation. This however makes for a bulky aircraft configuration, as in particular both coplanar wings need to be sufficiently spaced (when viewing the aircraft in its vertical configuration) to allow a full rotation of the fuselage during transition from vertical to horizontal flight, resulting in a significant aircraft footprint in vertical configuration, occupying a significant space when parked on a landing pad and potentially incompatible with the demands of future air transportation where a significant increase in urban air transport flights and therefore increase in number of aircraft is expected in the near future.

For present purposes the yoke comprises all portions of the aircraft upon which the fuselage pivots by means of said pivot.

In the present invention there is preferably provided at least one port and at least one starboard propulsion unit. This enables the aircraft to be steered by altering the degree of proportion exerted by the port and starboard propulsion units, the resulting differential force changing the orientation of the aircraft.

The propulsion units are preferably placed symmetrically upon the aerofoils of the yoke. This reduces the complexity of controlling changes in orientation. The propulsion units are preferably symmetrical fore and aft. This provides a balance due to more even weight distribution between the fore and aft portions of the yoke upon which the fuselage is supported.

More specifically the present invention preferably comprises a distributed electric propulsion system, although in its broadest conception the present invention did not necessarily rely on electric propulsion but may use other conventional propulsion mechanisms, such as a gas turbine. However, electric propulsion is preferred as this provides means for rapid, responsive and directly controllable navigation of the aircraft by means of the propulsion units giving differential levels of proportion.

Distributed electric propulsion architecture may be powered directly by batteries in full electric configuration, by fuel cells or by a hybrid power unit.

An airborne, urban mobility vehicle is an aircraft capable of transporting a human being, or payload of similar weight for a distance and at a height relevant for urban mobility. This A-UMV concept of the present invention can easily be scaled from a single seater/rider configuration up to 4-Sseater/rider configuration and beyond. For example, “Present invention-2Rh” refers to a 2 Riders Hybrid Present invention aircraft.

In the present invention the aerofoils are preferably fixed wings in relation to the rest of the yoke and the yoke as a whole only moves with respect to the fuselage at the pivot. This greatly reduces the number of moving parts, providing a simpler and more robust design. This arrangement means that flight control surfaces may not be required and in conjunction with a suitable propulsion unit configuration enables navigation to be undertaken purely by adjusting the output of the propulsion units. For example, the aircraft of the present invention requires no tail section making the design simpler, more cost effective and the mechanical simplicity increases safety as there are fewer parts to potentially malfunction.

In the present invention, the propulsion units are preferably placed fore and aft and further preferably symmetrically and if not literally symmetric then symmetric to the extent of having equal numbers of units, with at least one propulsion units on each aerofoil, this enables manoeuvrability (i.e. navigation) of the aircraft to take place based upon altering the output of the propulsion units.

To this end preferably at least one aerofoil has two propulsion units thereon, the propulsion units being placed respectively port and starboard.

In a preferred embodiment of the present invention four propulsion units on the fore aerofoil and four propulsion units on the aft aerofoil. This provides both the potential for manoeuvrability to be determined entirely by the output of the propulsion units and also provides propulsion unit redundancy so that manoeuvrability may be maintained even if the propulsion unit becomes defective. This greatly increases the safety of the aircraft. It also provides greater stability in flight.

The propulsion units are preferably fixed pitch propeller propulsion units these are simple and lighter than variable pitch propellers. Variable pitch propellers are not required because in the present invention, particularly with multiple units fore and aft change in unit moment can be significant enough to obviate the need for changing propeller pitch to effect manoeuvrability of the aircraft. The propulsion units are preferably electric propulsion units, this gives a wider range of rotational speed at which both high efficiency and controllability are possible. This is particularly important when manoeuvrability of the aircraft is derived from the propulsion units rather than from control surfaces such as a rudder or ailerons. The use of fixed pitch propeller is made possible by the fact that electric motors operate more efficiently across a wide range of speed and can change speed very quickly, compared with internal combustion engines that are best operated at a constant RPM. With internal combustion engines, the propeller pitch is therefore changed to increase or reduce aircraft speed, whereas with an electric motor the speed of the motor may be changed to also change the speed of the aircraft.

The aircraft of the present invention preferably comprises a flight control unit, the flight control unit controlling power to a distributed electric propulsion system of electric propulsion units driving fixed propellers on all propulsion units. This provides a means to control manoeuvrability in flights of the aircraft based upon differential output from the propulsion units and can also provide consequential greater stability in flight. In some forms of the present invention this provides that:

the flight control unit is configured to manoeuvre the aircraft in one or more of pitch, roll and yaw by means of adjusting the relative propulsive force provided by the propulsion units and this also provides a means of providing greater flight stability. Very preferably the flight control unit is configured to manoeuvre the aircraft in one or more of pitch, roll and yaw by means of adjusting the relative propulsive force provided by the propulsion units by means of the relative propulsion moments about the centreline of the aircraft. This is achieved by providing propellers which are paired in CCW rotation and CW rotation. And which also delivers further stability in flight. More preferably, the flight control unit is configured to manoeuvre the aircraft in one or more of pitch, roll and yaw by means of adjusting the relative propulsion moments (rotational moments, thrust generated moments or a combination of both) about the centreline of the aircraft. Hence, preferably this is why some propulsion units rotate CCW and some CW.

This reduces or preferably obviates the need to auxiliary flight control surfaces, such as rudder, elevators, elevens and ailerons depending upon which selection is made.

For example, Ailerons are normally used to roll the aircraft in level flight (i.e. rotate the aircraft about its centreline, the line defined by the direction of travel). In the illustrated embodiment of present invention (in particular based on FIG. 4 propeller configuration) if CW propulsion units 1/2/7/8 are made to rotate faster than CCW propulsion units 3/4/5/6 it creates an imbalance between the moments of the CCW and CW propulsion units and the aircraft rolls to the left (CW moment greater than the CCW moment).

The flight control unit is preferably configured to manoeuvre the aircraft from a vertical take-off to a horizontal flight orientation by means of adjusting the relative propulsive force provided by the fore and aft propulsion units.

The flight control unit is preferably configured to manoeuvre the aircraft in all of pitch, roll and yaw by means of adjusting the relative propulsive force provided by the propulsion units.

In all cases the flight control unit must be fully compliant with regulatory requirements and hence once this had been achieved each additional function serves to improve reliability, reduce complexity and reduce weight as functions normally undertaken by other equipment.

For example, a horizontal stabiliser (tail plane) and vertical stabiliser (rudder) can be omitted as adverse yaw can be accommodated by adjusting the propulsion units (as outlined in principle above for example as described in more detail below). Similarly, ailerons can be omitted as roll (banking) can be accommodated by adjusting the propulsion units. In the same way, elevator and/or elevens can be omitted as pitch can also be accommodated by adjusting the propulsion units.

These features when used all together can mean that, for the purposes of manoeuvring the aircraft in flight, the movable parts of the main body of the aircraft are only the port and starboard pivots of the fuselage and the propulsion units (to the extent that those are in motion to directly produce thrust).

The preferred mode of distributed electric propulsion of the present invention preferably comprises four propeller propulsion units on the fore aerofoil and four propeller propulsion units on the aft aerofoil, the units preferably being placed symmetrically about the fore and aft of the aircraft. DEP (Distributed Electric Propulsion) and specifically DEP in this format enhances lift, reduce drag and hence energy consumption, reduce wing mass/size to offer a reliable, efficient and compact solution to both proportion and navigation/manoeuvrability. Because it allows for smaller wings it reduces drag. The best improvement comes when some (4) of the 8 propellers are also switched off on forward level flight and even greater benefits come from folding the propulsion units that have been turned off. Specifically, the electric propulsion units are required to be individually controllable and this individual control can be naturally extended to control for the purposes of manoeuvring the aircraft. This reduces the number of movable parts. Specifically, the movable parts of the main body of the aircraft are limited to the port and starboard pivots of the fuselage and the propulsion units, the propulsion unit potentially only requiring a rotor and related bearing structures thus potentially giving only n propulsion units plus fuselage as the main moving parts of the aircraft. This greatly simplifies design and production and increases reliability. Further this simplicity, particularly with a plurality of propulsion units, such as two fore and two aft provides reduced variables for computationally and so automatically maintaining stability in flight and as such a more stable and controllable plane.

Further, the preferred configuration of propulsion units said four propeller propulsion units on the fore aerofoil and four propeller propulsion units on the aft aerofoil gives even greater reliability as up to 50% of the propulsion units may fail while still retaining a reasonable, if emergency, level of manoeuvrability of the aircraft. The invention, such as in the illustrated embodiment, is therefore configured to size each of the 8 propulsion units (such as when driving suitable propellers) such that if a least 2 fail, and indeed if up to 4 fail, the aircraft can still safely land. It may not have the performance to take-off (as to ascend the aircraft needs to accelerate and therefore have a thrust in excess of the mass) but it would be able to land as in this case the aircraft has to be decelerated sufficiently to reach the ground with sufficiently low speed, thus in this case require a thrust level lower than the aircraft mass This is a significant safety advantage of the preferred, illustrated, example of the present invention.

A key option for the present invention is the use of two fixed wings (fore and aft) of the tandem wing configuration each equipped with, preferably, fixed propellers/thrusters and instead only the fuselage rotates when transitioning from vertical to level flight as illustrated hereafter:

The invention differentiates over concepts such as MOBI by AerospaceX by the use of 2 wings, fore and aft instead of only one, this has the advantage that the use of 2 wings (forward and aft) allows generating a significant moment to pivot/transition the aircraft from vertical to level flight using differential thrust/lift between the 2 wings/sets of propulsion units without external force. Mobi has only one wing which results in little leverage to pivot the wing. Their outer most propellers are vertically staggered to some extent to offer some moment but they are limited by the fact they only have one wing and so it is not as effective as having 2 horizontally and vertically staggered wings and 2 staggered sets of propulsion units. As such, in order to ease pivoting/transitioning, Mobi likely relies on the mass/inertia of the pod by pulling the wing down via its mechanism and help the wing pivot from vertical to horizontal. This results in significant load the mechanism and render the mechanism critical.

The main benefit of the Present invention is its simplicity over its competitors in this rapidly developing market.

### DETAILED DESCRIPTION

The present invention will now be illustrated by means of the following figures, in which:

FIG. 1—Present invention during Level Flight;

FIG. 2—Present invention in a vertical configuration whilst on the ground;

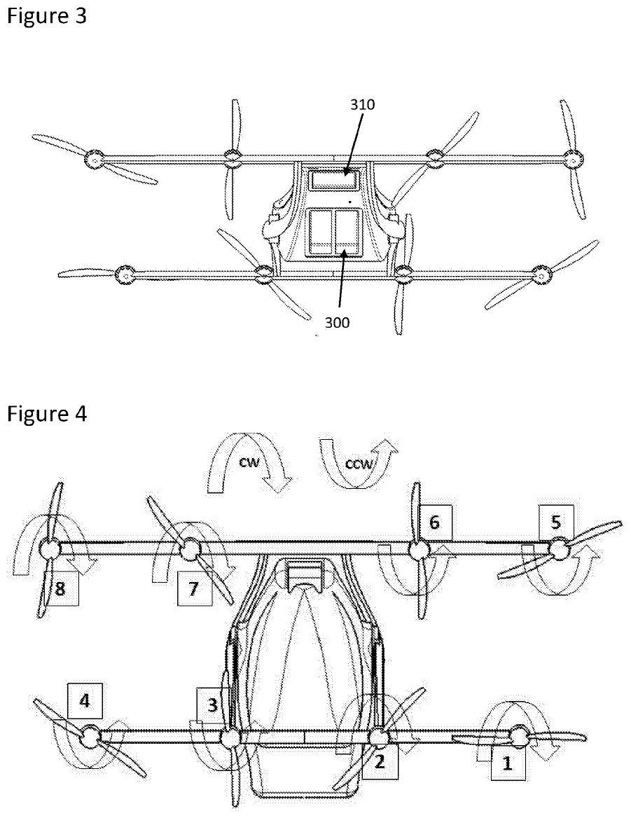

FIG. 3—Present invention showing rear view with parachute and power module location;

FIG. 4—Propulsion unit (motor/propeller) configuration and labelling;

FIG. 5—Present invention transitioning from Vertical to Level Flight;

FIG. 6—Pitch control of the aircraft in vertical flight;

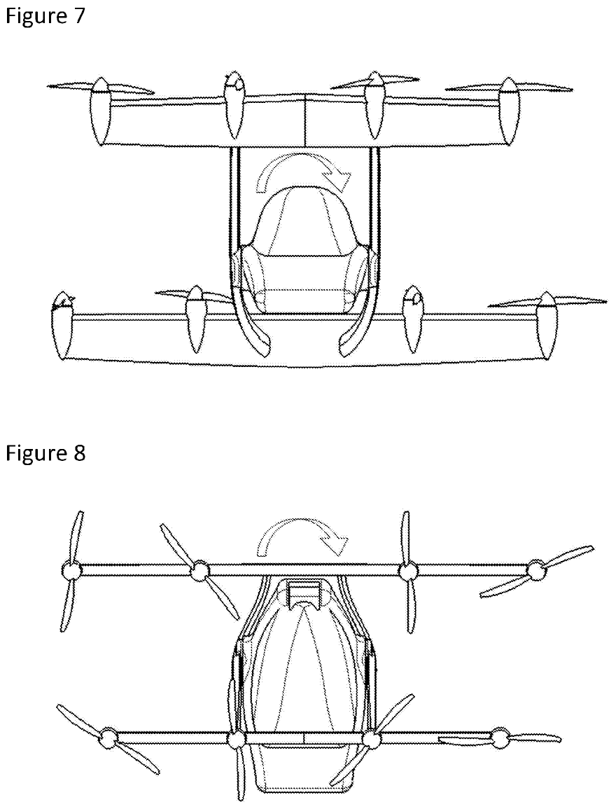

FIG. 7—Roll control of the aircraft in vertical flight;

FIG. 8—Yaw control of the aircraft in vertical flight;

FIG. 9—Yaw control of the aircraft in level flight;

FIG. 10—Pitch control of the aircraft in level flight;

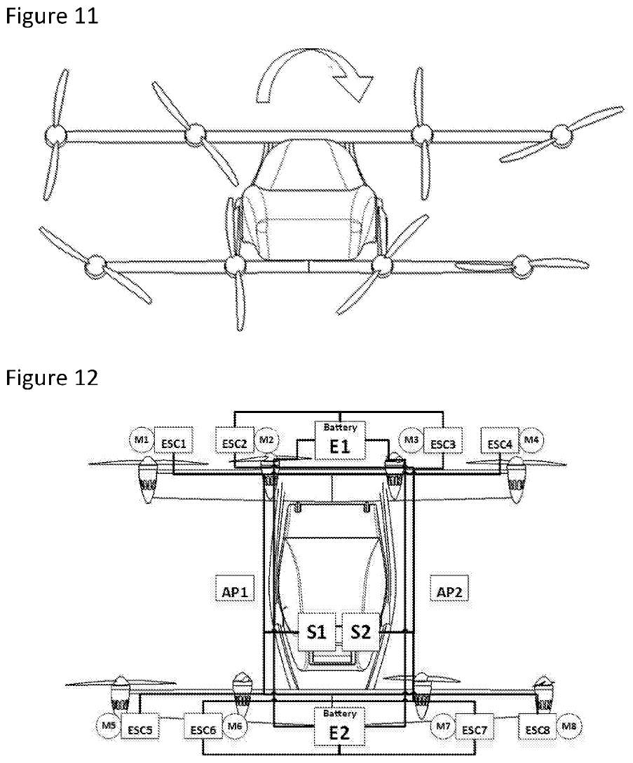

FIG. 11—Roll control of the aircraft in level flight;

FIG. 12—Redundant Power Distribution and Propulsion System Architecture;

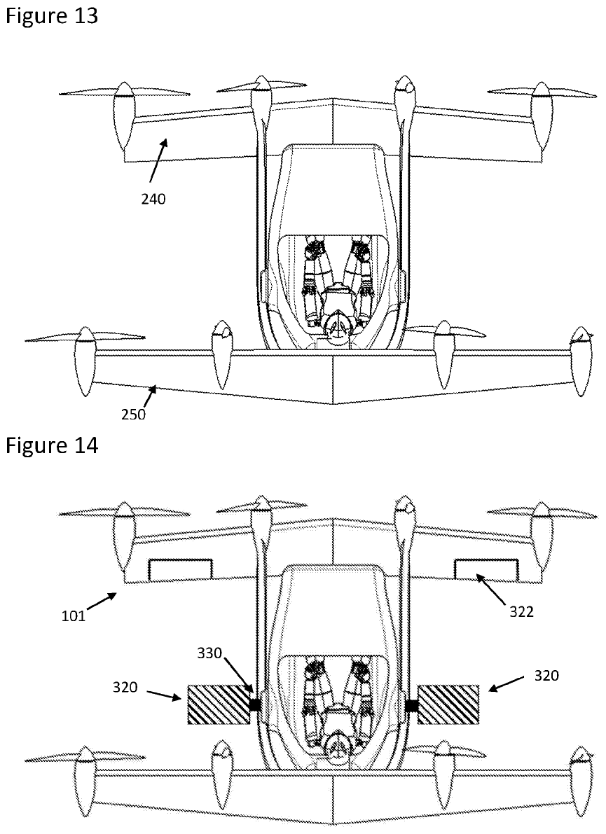

FIG. 13—Alternative wing configuration showing swept and tapered wing;

FIG. 14—Example of control surfaces, “canard” and ailerons;

FIG. 15—Alternative propulsion unit configuration showing a combination of 3-bladed and 2-bladed propellers

FIG. 16—Three tractor motor/propeller version of the Present invention;

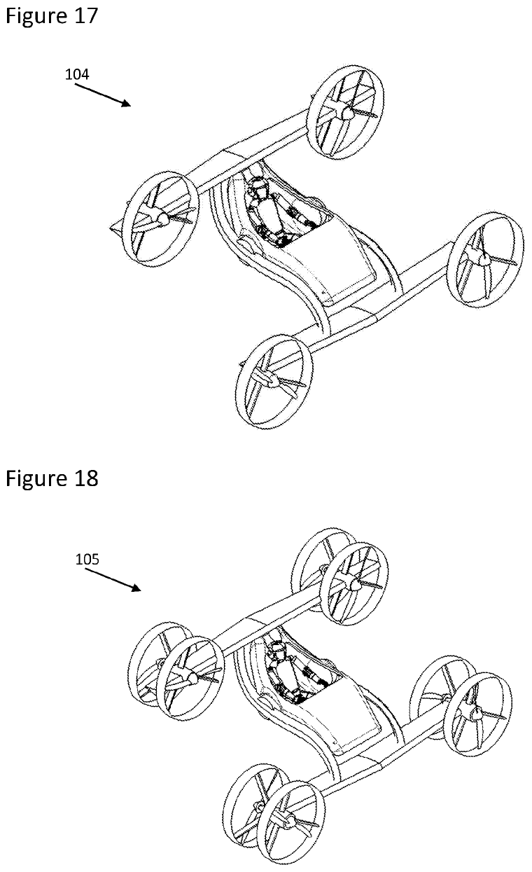

FIG. 17—Four tractor ducted motor/propeller version of the Present invention;

FIG. 18—Four tractor+four pusher (eight in total) ducted motor/propeller version;

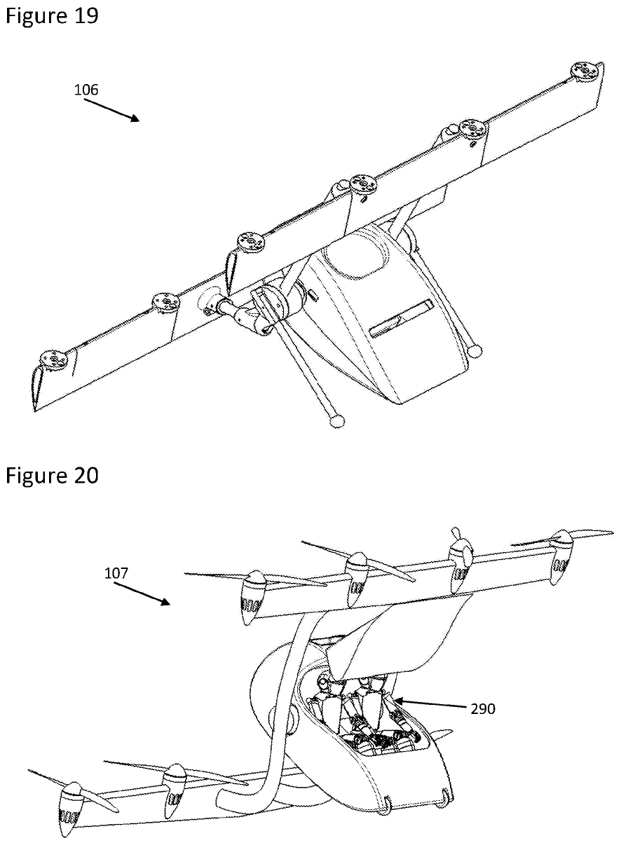

FIG. 19—Present invention fitted with skids for ground support;

FIG. 20—Example of 2-seater version with fuselage acting as tripod and fitted with a pair of nose wheels;

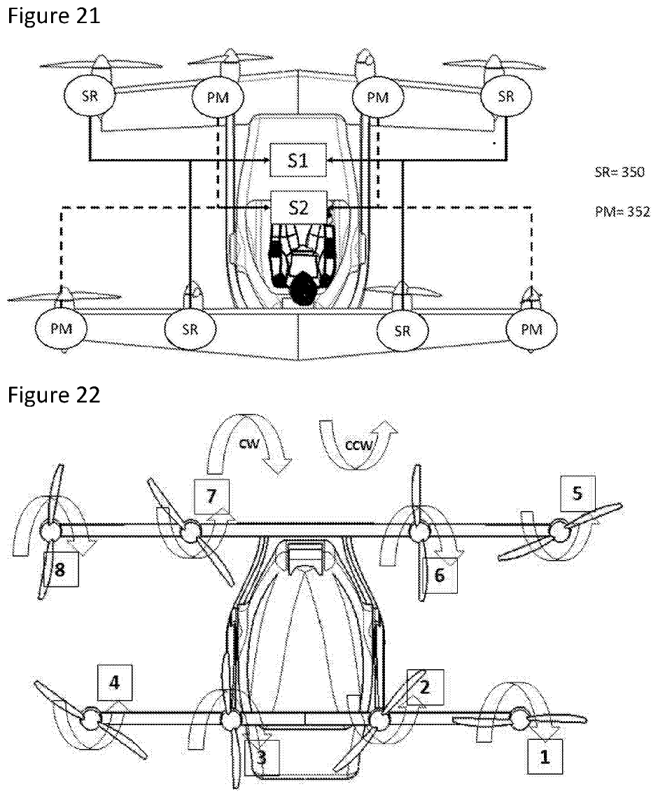

FIG. 21—Example of dissimilar motor technology and configuration;

FIG. 22—Alternative propulsion unit (motor/propeller) configuration and labelling;

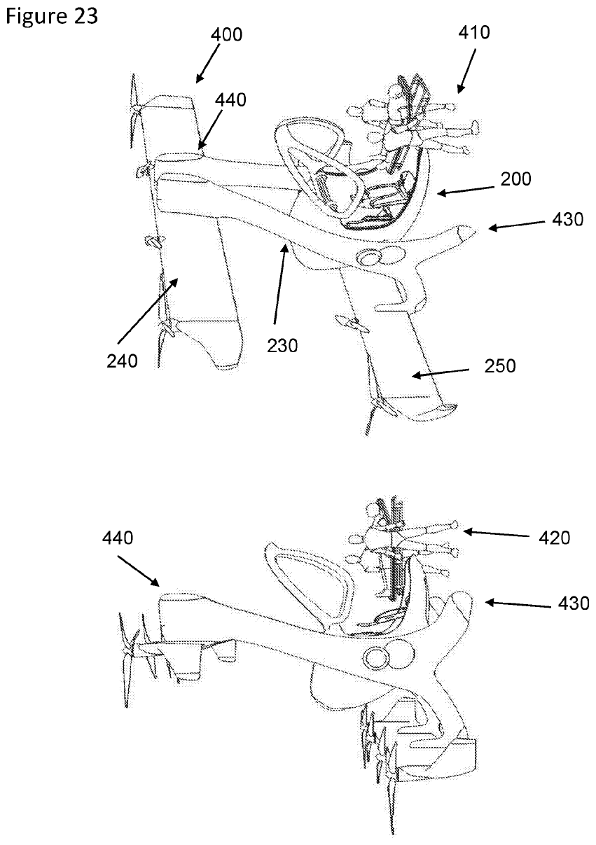

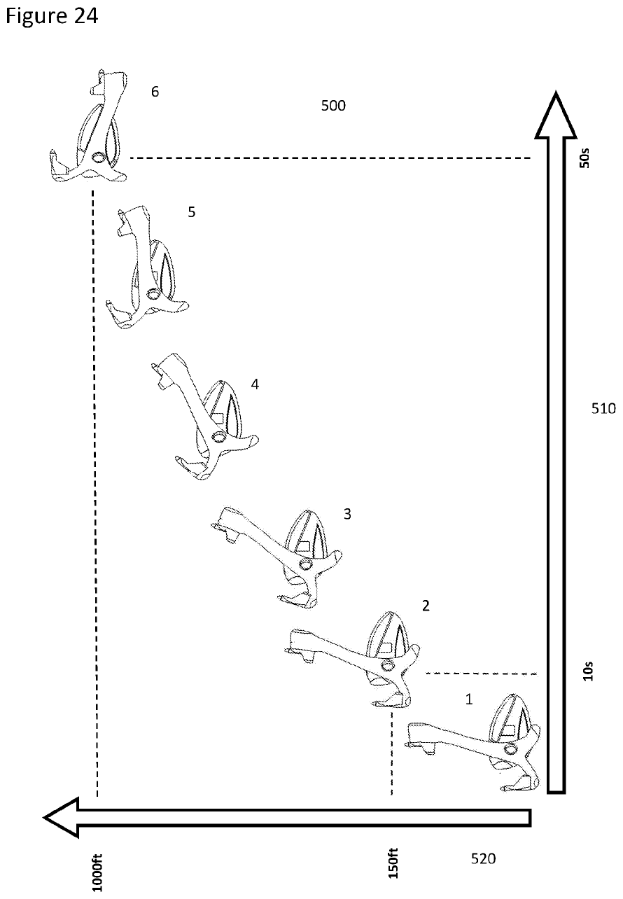

FIG. 23—Example of a medical transport version of the present invention;

Whilst the above figures and the description below describes combinations of features those features may be present separately as defined in the description or in the claims.

The above drawings provide isometric views of the present invention. These drawings illustrate the forward and aft staggered and offset wings, an example of eight distributed electric motor propellers, fuselage capable of housing passenger(s), the yoke with its structure of beams that link the forward and aft wings together as well as the pivot that allows the fuselage to rotate about the yoke assembly and landing skids supporting the aircraft whilst on the ground

The Present invention is also depicted in level flight configuration (horizontal or quasi-horizontal flight phase during cruise) as well as in vertical flight configuration (vertical or quasi-vertical flight phase during take-off and landing).

The drawings also provide isometric views of an example configuration of the present invention showing a single passenger aircraft with opened canopy, when the aircraft is on the ground before take-off or after landing.

The drawings also provide isometric views of an example configuration of the present invention showing a medical transport aircraft with opened canopy, when the aircraft is on the ground being loaded with a patient on a stretcher by two paramedics.

In flight the canopy is a preferred option for passenger safety and comfort but for clarity the canopy may not always be displayed in some of the illustrations provided.

In the following figures like numerals represent like features. The aircraft 100 of the present invention has the following features:
100, A-UMV
101 to 107 A-UMV variants;
200, passenger fuselage;
202, alternative ‘payload’ fuselage
220, a yoke;
230, 230′, port and starboard arms of the yoke;
240, fore aerofoil;
240′ swept aerofoil example;
242 fore extremity of yoke arm 230 joins to fore aerofoil 240;
250, aft aerofoil;
250′ aerofoil example;
252 aft extremity of yoke arm 230 joins to aft aerofoil;
260, 260′ etc., propulsion unit;
270 Pivot;
280 Canopy;
290 Pilot;
300 Bays for batteries/power-packs
310 parachute bay;
320, 320′—canards;
330 canard pivot;
340 wing end plates—inward;
340′ wing end plates outward;
350 switched reluctance (SR) motor; and
352 permanent magnet (PM) motor.
400 Medical transport variant
410 Patient and stretcher
420 Paramedics
430 Landing skids

FIG. 1 shows the present invention during Level Flight; and

FIG. 2 shows the present invention in a vertical configuration whilst on the ground.

The ground configuration is essentially the same as the configuration for vertical take-off, it merely being that the optional canopy 270 would be closed on take-off. Similarly, FIG. 2 shows a pilot/occupant, the present invention is not limited to a passenger carrying aircraft although a preferred embodiment is for passenger carrying. In any case, fuselage 200 comprises a payload carrying space, such as for occupancy by a pilot/passenger(s).

The present invention provides an aircraft for use as an airborne, urban mobility vehicle and capable of vertical take-off and landing; the aircraft comprising

a fuselage freely pivoted between lateral arms of a yoke;

the yoke extending fore and aft and, at or towards the extremities of the arms:

the respective fore portions are linked laterally together by an aerofoil;

and the respective aft portions are linked laterally together by an aerofoil;

and at least one of the fore and aft aerofoils having mounted thereon one or more propulsion units.

FIG. 3 shows a rear view (i.e. Aft of the aircraft), this illustrates a preferred staggered offset wing configuration mode comprising eight propulsion units set upon substantially (within 5°) parallel or parallel aerofoils the aerofoils being both horizontally and vertically offset from one another, preferably the aft aerofoil is configured in normal flight to be above the fore aerofoil. This makes the pilot view in line with conventional aircraft and enables simpler embarkation and disembarkation when the aircraft is in its vertical configuration and the fore wing is now significantly above the ground. This figure also shows the separate feature of a preferred parachute and/or power module location.

Alternatively, a plurality of power modules may be distributed within the structure of the wings in a similar way conventional aircraft would store fuel in their wings. In this preferred arrangement, high power and potentially flammable batteries are located away from the occupants of the aircraft.

The manner in which the present invention, as exemplified by this preferred embodiment as shown in FIGS. 1 to 3 operates will now be considered.

As a reference FIG. 4 provides an example propulsion unit (motor/propeller) configuration and labelling.

FIG. 5—illustrates a key feature of the present invention, specifically the mechanism for transitioning from Vertical to Level Flight. The transition from vertical to level flight is achieved by a combination of differential thrust between both fore and aft wings and differential aerodynamic moments from control surfaces (if fitted) allowing the aircraft to pivot (pitch forward on take-off or backward on landing) and seamlessly transition from vertical to level flight following take-off and with the reverse transition, back to vertical flight prior to landing, as illustrated hereafter FIG. 5. As can be seen from that Figure the present invention starts out in the configuration shown in FIG. 2, exerts vertical thrust for vertical take-off and then transitions to the configuration shown in FIG. 1 configured for horizontal flight.

### Rotation of the Fuselage Relative to the Yoke

To accommodate the change in aircraft attitude from vertical to horizontal the fuselage rotates relative to the yoke. As the fuselage mass distribution can be balanced by design, the effort required to level the fuselage is minimal. Moreover, as the fuselage does not incorporate any spinning shaft, there is no gyroscopic effect to accommodate, unlike during the rotation of spinning motors/propellers/thrusters as experienced with tilt-wing, tilt-rotor or vectored thrust VTOL design. Furthermore, this mechanical arrangement of a pivot is extremely simple and for practical purposes it would be unlikely for it to malfunction in any meaningful way. Even if it did malfunction, there was the aerodynamics of the invention would be non-optimal it would not suggest an immediate disaster situation such as would occur in other designs were multiple components need to simultaneously rotate. Even incomplete rotation of the pivot of the present invention maintains symmetry and hence a higher likelihood of maintaining control.

A set of mechanical stops may be employed to ensure that the fuselage cannot rotate freely about the pivot and is constraint between its level flight position and its vertical flight position. This protects against a failure of the mechanism that would result in a mechanical disconnect (for example a severing of the output shaft of the mechanism).

Typically, the range of motion of the fuselage would be 90 degrees, between its vertical configuration (fuselage at substantially 90 degrees from the chord of the wings) and its vertical configuration (fuselage at substantially 0 degrees from the chord of the wings). It may however be beneficial to position the mechanical stops such as to allow the fuselage to rotate throughout a larger range of motion, for example 100 degrees, such as to allow the fuselage nose to rotate closer to the ground and ease passenger embarkation and disembarkation by reducing the aircraft ground clearance This useful feature is depicted in FIG. 23 where the fuselage is over-rotated to allow paramedics 420 to the patient and stretcher 410 inside the fuselage of a medical transport variant 400 of the present invention.

Hence, a failure of the fuselage during transition has little consequence to the safety of its occupant, Preferably the nose of the fuselage is heavier than the tail as this even avoids the discomfort of possibly flying upside down as the fuselage will always be self-righting. The rotation of the fuselage pivoted between lateral arms of a yoke is preferably mediated so as to limited or enhance movement that would otherwise occur if the fuselage where freely rotatable with respect the yoke.

The mediation may be by a combination of mechanical stops and a mass and aerodynamic bias. For example, the shape of the fuselage may be aerodynamically designed to result in a moment that would bias the fuselage, under aerodynamic loads, against a first stop designed to prevent over-rotation of the fuselage and keep the fuselage level during cruise (i.e. level flight). Similarly, the weight distribution of the fuselage may be carefully designed to result in a moment that would bias the fuselage, under the effect of gravity, against a second stop designed to keep the fuselage level during vertical flight (i.e. Take-off and landing).

The mediation may be by means of a resistive torque such as that provided by a non-readily back-driveable actuator, a braking arrangement or a clutch.

The mediation may be by means of an actuator to drive rotation about the pivot.

The mediation may be by means of an active control of the fuselage position during level flight (i.e. cruise) to position the fuselage in an optimum position within the air flow so as to minimise the aerodynamic drag of the fuselage and constantly optimise energy efficiency.

The mediation may also be used to determine the position of the fuselage centre of mass, in conjunction with a means of measuring the fuselage mass using for example load sensors located at the pivots. Knowing the exact position of the fuselage may be desirable to inform the aircraft flight control computer of the precise aircraft configuration and enhance safety and comfort of flight.

Rotation may be limited by mechanical stops, such stops may be repositionable, such as to accommodate different ranges of movement in different flight stages. This protects against dramatic movements, such as flipping of the fuselage due to freak environmental conditions.

### Controlling Transition of Present Invention

As mentioned, the transition from vertical to level flight is preferably achieved by differential thrust between both fore and aft wings allowing the aircraft to pivot (pitch forward on take-off or backward on landing) and seamlessly transition from vertical to level flight following take-off.

If control surfaces are present, for example ailerons 322 as depicted in FIG. 14, the differential thrust of the propulsion units may be complemented by aerodynamic moments from conventional control surfaces and assist in creating a pitching moment to transition from vertical to horizontal flight and conversely.

Preferred options to effect this transition from vertical to horizontal flight (and by inference in the reverse direction also) are as follows:

Sensors fixed to the yoke, such as on the aerofoils (aka wings): A first preferable option consists in referencing (“fixing”) the flight computer sensors (e.g. compass, gyroscope, accelerometers etc.) relative to the wings of the aircraft. In this case, the flight controller “knows” that it is going to be rotated with respect to the earth referential during the transition, and it is programmed to commands/controls the thrusters to pitch the wings from vertical (e.g. 90 deg pitch) to horizontal (e.g. Odeg pitch) whilst commanding the fuselage to remain quasi-level at all time (using any suitable angular/position/attitude sensor). In doing so the wings “lead” by rotating ahead of the fuselage and the fuselage rotating mechanism “follows” the wings and rotate relative to the wings accordingly to keep the passengers in a comfortable level or quasi-level position.

Sensors fixed to the fuselage: A second option consists in referencing (“fixing”) the flight computer sensors (e.g. compass, gyroscope, accelerometers etc.) to the fuselage. In this configuration the flight computer “does not know” that it is going to be rotated with respect to the earth referential during transition. The fuselage is commanded to rotate which transiently causes it to be slightly out of alignment with the horizontal direction, forcing the flight controller to adjust the thrusters to cause the wings to rotate with respect to the earth referential and level the orientation of the rotating fuselage. In doing so, the fuselage “leads” the wings which are forced to “follow” the fuselage rotation and rotate with respect to the earth differential from vertical to horizontal.

In a redundant flight control architecture, both strategies may be implemented, with a redundant set of sensors and computers (fixed to the wings) and a redundant set of sensors and computers (fixed to the fuselage) both in parallel controlling the aircraft attitude.

One flight controller (for example the system fixed to the fuselage, the main system) would be given authority over the other flight controller (for example the system fixed to the wing, the back-up system) and in the event of the main flight controller failing for malfunctioning, the back-up system would safely take over.

By implementing dissimilarity in the software, sensors and computers, this would allow meeting stringent safety requirements, together with the redundant and segregated power distribution architecture and the multitude of redundant thrusters.

### Fuselage Mechanism

Unlike conventional VTOL aircraft (past, present or in development) that rely on rotating wings, tilting rotors and/or vectoring thrusters by mechanical means, the proposed concept in fact effect the wings rotation purely via means of differential thrust/differential lift/differential moments between the forward and aft wings. For passenger comfort, but not required for safe flight, the fuselage is actuated to remain level (e.g. horizontal) or quasi-level. The actuation mechanism of the fuselage is non-critical and is potentially only lightly loaded as both its mass and aerodynamic moments may be balanced and minimised about its centre of rotation by design. Moreover, in the present invention there are preferably no rotating/spinning masses inside the fuselage for the purposes of adjusting flight of the overall aircraft. A mass in this sense being an object intended to navigate the aircraft by altering its aerodynamics (and excluding incidental rotating objects such as gyroscopes, wheels, knobs). The fuselage rotation itself does not generate any (significant) gyroscopic effect, which is often source of instability during the transition of VTOL aircrafts. Unlike known designs the present invention avoids configurations where rotating motors/rotors/fans/propellers or wings are moved by mechanisms during transition (e.g. MOBI, Lilium, Vahana, etc.) and as such provides safety and simplicity.

Actuation of the fuselage can be achieved by any suitable mean but may typically be implemented by using:
(a) a direct drive rotary actuator, where the output of the rotary actuator is aligned with the axis of rotation of the fuselage; or
(b) an indirect rotary actuator, where the output of the rotary actuator is offset from the axis of the axis of rotation of the fuselage and a link and bell-crank connect the rotary actuator to the fuselage axis of rotation; or
(c) a linear actuator with its output connected to the fuselage axis of rotation via a bell-crank;

### Motor Propeller Sizing Criteria

With reference to the simplified system architecture depicted in FIG. 12, the motors are sized to ensure that in the event of a failure of either 81 or 82 systems the aircraft may continue to operate albeit under degraded performances particularly during the vertical flight phase during which the aircraft may only be able to land (i.e. control the rate of decent by providing vertical negative acceleration) but not take-off (i.e. provide positive vertical acceleration). Under failure conditions, depending on motor sizing, the motors may have to be over-driven to provide sufficient thrust and may require inspection following an emergency landing.

The level of redundancy and the number of independent batteries, motors, motor controllers, flight computers and electrical network will be driven by the level of safety imposed by certification requirements and is likely to be in excess of two (S1 and S2) as suggested in FIG. 12.

The aircraft may be equipped with a parachute otherwise referred to a BRS (Ballistic Recovery System) independent from both Normal and Emergency systems as commonly and successfully implemented on light aircraft. This does not preclude to the implementation of a redundant system architecture as parachutes tend to be ineffective at lower altitudes and generally cannot be taken credit from for the purpose of the certification of the aircraft.

### Aircraft Control

In both Vertical and Level Flight phases, the Present invention attitude is controlled by combinations of the differential thrust/lift of fore and aft wings propellers and/or the differential thrust/moment of counter-rotating propellers and conventional control surfaces if installed, such as ailerons. In both Vertical and Level Flight phases, the Present invention attitude is controlled by combinations of differential moment, from differential rotating speed for CCW and CW propulsion units that allow for the control of yaw or roll (depending on whether the aircraft is flying vertically or level), this is a significant factor in quantitative terms in the present invention and allows for the use of a fixed propeller without disadvantage over a variable pitch propeller.

The information provided for the illustrated, described and preferred aircraft as described herein has been validated by flight in a large indoor enclosed space of scale models (of over 62 cm and later of over 100 cm wingspan) of this aircraft and the statements made herein have been validated by flight testing of those models.

### Vertical Flight Control

During Vertical flight (e.g. Take-off and landing), roll, pitch and yaw are controlled as Shown in FIG. 4 which provides an example of motor/propeller configuration and labelling for the present invention and as used in the drawing's description.

FIG. 6 shows Pitch control of the aircraft in vertical flight. Pitch is controlled by varying the rpm of either front or rear wing propellers, e.g.: if propellers 5, 6, 7, 8 rotate faster than propellers 1,2,3,4 the craft will pitch forward:

FIG. 7 shows that Roll may be controlled by varying the rpm of either left or starboard wing props, e.g.: if propellers 3,4,7,8 rotate faster than propellers 1, 2, 5, 6 the craft will roll to the left:

FIG. 8 shows Yaw control of the aircraft in vertical flight. Yaw is controlled by varying the rpm of either CW rotating or CCW rotating propellers, e.g.: if CCW propellers 3, 4, 5, 6 rotate slower than CW propellers 1, 2, 7, 8 the craft will yaw CW:

### Level Flight Control

FIG. 4 shows an example of motor/propeller configuration and labelling as a reference in the further description.

During Level flight (e.g. cruise), roll, pitch and yaw are controlled as follows:

FIG. 11 shows Roll control of the aircraft in level flight. Roll is controlled by varying the rpm of either CW rotating or CCW rotating propellers, e.g.: if CCW propellers 3,4,5,6 rotate slower than CW propellers 1,2,7,8 the craft will yaw CW.

FIG. 9 shows Yaw control of the aircraft in level flight. Yaw is controlled by varying the rpm of either left or starboard wing propellers, e.g.: if propellers 3,4,7,8 rotate slower than propellers 1,2,5,6 the craft will roll to the right.

FIG. 10 shows Pitch control of the aircraft in level flight. Pitch is controlled by varying the rpm of either front or rear wing propellers, e.g.: if propellers 5, 6,7, 8 rotate faster than propellers 1,2,3,4 the craft will pitch forward.

It should be noted that the motor/propeller configuration and labelling example provided in FIG. 4 does not change whether the aircraft is in vertical or level flight.

CCW and CW propellers have a different profile designed to accommodate the direction of rotation whilst providing thrust in the same direction. As such a motor/propeller can only be configured from CCW to CW (and conversely) by physically replacing the CCW propeller for CW propeller (and conversely). It is not simply a case of reversing the motor direction of rotation.

There are however different ways of configuring motor/propellers direction of rotation as illustrated in FIG. 22. FIG. 22 shows an alternative example of motor/propeller configuration and labelling applicable to the above mechanisms. This alternative configuration is similar to the octocopter motor/propeller configuration commonly implemented on some multi-copters. In this configuration, the direction of motor/propeller 2 and 3 as well as 6 and 7 are inverted compared with the configuration proposed in FIG. 4.

### System Architecture

The proposed Present invention concept relies on Distributed Electric Propulsion or DEP (in this example 8 electric motors and propellers) to reduce wing surface and drag. This provides additional freedom to implement a redundant system architecture in order to improve safety and meet certification requirements.

The diagram in FIG. 12 details a simplified example of redundant architecture comprising of 2 normal systems (S1 and 82) and an emergency system (E):

FIG. 12 shows a preferred redundant Power Distribution and Propulsion System Architecture

The layout of each normal systems 81 or 82 is such that they each allow full control of the aircraft. In particular, each 81 and 82 systems is connected to the necessary combination of CCW and CW propellers on each fore and aft wing to allow full pitch, roll and yaw control in both vertical and level flight with either 81 or 82 set of propellers/motors/controllers.

The motors M1 to MS are in this embodiment distributed evenly between the forward and aft wings and the ESC (electronic speed controllers) required to control each motor may be located inside the wings if space permits, in order to reduce wire count and wire length, or within the fuselage if the wings are too small.

A pair of redundant and dissimilar AP (autopilots) is used to assist in the control of the aircraft in flight and may be located either within the fuselage or wings.

The power source for systems 81 and 82 (e.g. batteries, fuel cells or hybrid units) may located within the fuselage for access but also to better weight distribution of the fuselage in an effort to balance the fuselage mass with its passengers and reduce the loading of the actuation system/mechanism.

Alternatively, the power sources may be located within the structure of the wings in a similar way conventional aircraft store fuel in their wings. This preferred arrangement has the benefits of avoiding the presence of potentially flammable battery within the fuselage and its occupants, as well as reducing the risk of electrocution arising from high power I high voltage batteries near passengers.

An additional Emergency power source (typically a dissimilar Emergency battery) can be used as a last resort to power either or both Normal systems in the event to a battery failure for example. To this effect, the emergency system is powered by Emergency batteries E1 and E2 (regardless of the normal system power source). To segregate the emergency from the normal system as much as practically possible (e.g. In the event of a fire), the emergency batteries are located in the fore (E1) and aft (E2) wings of the aircraft. In addition, dissimilar battery technology may be implemented for the emergency system, in particular if the normal system is also battery powered. The emergency batteries are size to meet the regulatory requirements for reserve fuel (typically 20 minutes).

### Wing Design

The wing design of the proposed concept is compatible with any of the modern wing configurations designed to enhance performance.

The wing design of the proposed embodiment may be based on any wing profile, it may consist of a simple straight constant chord wing profile to ease manufacturing and reduce costs, however any other wing configuration may be implemented, for example the wings may be tapered, swept, delta shaped, etc.

FIG. 13 shows an alternative example of a swept and tapered wing. The forward wing of the aircraft is known as a swept wing whereas the aft wing is known as a straight tapered (trapezoidal) wing:

The preferred configuration (e.g. FIG. 1) features 2 backward staggered wings, however a forward staggered arrangement may be implemented and/or the number of wings may be increased to provide additional lift and/or additional control surfaces. For example, additional small wings (sometimes called canard) may be fitted to the hinge point of the fuselage to improve stability and/or act as an elevator.

The current embodiment does not feature any conventional control surfaces, instead relying on differential thrust and/or differential lift to manoeuvre the aircraft about all axis (e.g. yaw, roll, pitch). However, the proposed concept is not limited to this embodiment and conventional control surfaces (e.g. Ailerons, elevators, slats, flaps, rudder) may be used to provide additional controllability, improve energy efficiency and/or allow the pilot to retain sufficient control over the aircraft in the event of a total loss of power/thrust for example or to reduce the stall speed of the wings.

FIG. 14 shows an example of control surfaces, “canard” and ailerons. Additional moveable control surfaces are depicted in the form of “canard” in this example fitted to the hinge of the fuselage as well as an example of more conventional ailerons (322) depicted on the forward wing of this illustration.

FIG. 15 illustrates an alternative embodiment of the invention, featuring a combination of 3 bladed propellers (1/4/5/8) and 2 bladed propellers (2/3/6/7). Three bladed propellers are typically less efficient than 2 bladed propellers, however they allow producing very similar thrust with shorter blades than a 2 bladed propeller would produce with longer blades. Due to the reduced blade length of the 3 bladed propellers, the propeller inertia is also reduced, allowing very similar thrust to be produced typically at a higher motor rpm. For a given propeller pitch, this can allow a 3 bladed propeller to propel the aircraft at a higher forward speed (during level flight) than a larger 2 bladed propellers with the same pitch (forward speed is the product of the propeller pitch and propeller speed). During the slow speed vertical flight phase all propellers have the same performance (i.e. produce the same thrust) but during the high-speed level flight phase, where speed matters more than thrust, the 3 bladed propellers may be preferable to the 2 bladed propellers. In this particular example, all four 2 bladed propellers may be stopped and folded during level flight to reduce drag, leaving the faster spinning 3 bladed propellers to propel the aircraft forward at a higher cruising speed, with little change to energy consumption. As an alternative to folding the 2 bladed propellers 2/3/6/7 to reduce drag, these propellers may be stopped in a position parallel to the wing angle of attack (as depicted in FIG. 15) to reduce drag, albeit less than if the propellers were folded.

### Alternative Thruster Configurations

The present embodiment features conventional fixed pitch propellers for simplicity and to reduce the weight of the aircraft. In its embodiment the proposed concept features 8 tractor propellers (4 CW and 4 CCW) to provide redundancy and improve safety. Ideally the propellers are distributed along the wing to provide the benefits of what is known as distributed propulsion (whereby blowing on the wing increases lift, allowing for a reduced wing surface and consequently a reduced drag and structure mass).

It is possible, with the advent of modern flight controllers and auto-pilot electronics and software, to configure the aircraft with as few as three propellers (for example two on the aft wing and one of the forward wing). However, the concept should preferably have a minimum of 4 propellers to ensure optimum controllability and it is unlikely that sufficient level for safety may be achieved with either only three or only four propellers

FIG. 16 shows a three-tractor motor/propeller version of the present invention. Similarly, the concept may have any number of smaller propellers (for example 6 on each wing for a total of 12 per aircraft), distributed along its wings to provide additional redundancy and further improve the performance of the distributed propulsion. There is also no requirement for an equal number of propellers per wings, and depending on the aerodynamic performance and configuration of each wings, the front wing may have fewer propellers than the aft wing and conversely.

Propellers may be ducted to improve thrust and efficiency (typically by reducing propeller tip losses and via the extra thrust/lift typically generated by the duct itself). The drawback of ducts however is that it may add more mass and complexity to the aircraft. Ducting some or all of the propellers may also protect the fuselage/passengers from the particular risk of propeller blade separation resulting from a failure of the propeller, which is significant because of their rotational speed. This may also be useful in protecting the remaining propellers from being damaged by the failed propeller. Indeed, without the shielding afforded by the propeller duct, the failure of one propeller may result in the failure of all propellers which could be catastrophic.

FIG. 17 shows a four-tractor motor/propeller version of the Present invention fitted with ducts. The following drawing depicts a four motor/propeller of the Present invention fitted with ducts.

An example of structure (in this case 3 struts) required to support is also depicted, illustrating the added complexity that comes with fitting ducts to propellers:

Tractor (i.e. In front of the wings, pulling on the wing) propellers/fans/thrusters may be replaced with pusher (i.e. behind the wing, pushing on the wing) propellers. Alternatively, a combination of tractor and pusher propellers may also be implemented.

FIG. 18 shows a four tractor+four pusher (eight in total) ducted motor/propeller version. The following drawings provide a further illustration of the use of ducted propellers, as well as another embodiment of an eight motor/propeller configuration (for redundancy purposes) fitted with four tractor motor/propellers as well as four pusher motor/propellers. In this case, each pair of motor/propeller will typically be fitted with counter-rotating motor-propellers to ensure that each propeller generate thrust in the correct direction.

Generally, more thrust is required in vertical flight phases than in level flight phases. As such, and in the interest of efficiency, some of the motor/propellers may be switched off during level flight phases and possibly fitted with folding propeller arrangements to further reduce drag in level flight.

Similarly, a combination of different types of propellers/thrusters may be implemented to offer a compromise between vertical thrust and level flight speed. For example, a set of large pitch I small diameter propellers may be implemented to allow for fast level flight speed with reduced motor torque, and a set of larger diameter propellers may be implemented to provide high thrust during vertical flight. Both sets of propellers may work together to provide the maximum possible thrust during vertical take-off and landing but the larger diameter propellers may be switched off during level flight to allow the aircraft to travel as fast as possible using as little energy as possible.

In the present invention propellers may be distributed against the wing within the same horizontal plane. It may however be possible to stagger the thrusters of each wing so that some thrusters may be fitted and blow above the wing and other may be fitted and blow under the wing.

### Ground Stability

FIG. 1 to FIG. 18 of the present invention have been depicted without landing gear or landing skids for clarity, however on the ground, the aircraft may preferably rest on a conventional landing gear comprising of shock absorbing struts and wheels, or simpler and lighter skids, similar to the skids of a helicopter, that would be designed with an element of flexibility and compliance in order to dampen the vertical velocity/loads of the aircraft during landing.

FIG. 19 shows a further configuration of the present invention fitted with skids for ground support. This version of the present invention features an example of skids to support the aircraft on the ground. This particular version features eight motor/propellers (not depicted) and another smaller aft skid (not depicted) to avoid resting on the aft wing when the aircraft is on the ground:

FIG. 23 shows a further example of skids 430 fitted to a medical transport variant 400 of the present invention. In this particular embodiment, skids 430 are fitted with an aerodynamic fairing designed to reduce drag in cruise.

FIG. 20 shows an example of 2-seater aircraft with the fuselage acting as tripod and fitted with a pair of nose wheel. Here, the rotated fuselage forms a tripod with the aft wing and act as a skid/landing gear. A set of wheels or pads may be fitted to the nose of the fuselage (in contact with the ground) and the degree of freedom of the fuselage mechanism may be exploited to provide the compliance and dampening required for a comfortable landing. This may be achieved using a linear spring/damper strut if using an indirect rotary or linear actuation system or a rotary damper with its output directly connected to the fuselage axis of rotation. Although this embodiment allows supporting the aircraft on the ground without additional skids, it is not preferred as it is less tolerant to a failure of the mechanism that would leave the fuselage in an intermediate position.

### Motor Configurations

The proposed concept relies on a number of thrusters, at least three but ideally four, to allow controlled and stable flight. Preferably, the proposed embodiment includes eight thrusters arranged in redundant pairs to add an element of safety.

The use of eight thrusters or more, distributed along the wing, enhances lift, allowing for a reduction in wing surface and a consequent reduction in drag and aircraft mass. This is known as distributed propulsion and although conventional engines, as found in existing VTOL aircraft, may be used to power each propeller/fan directly or indirectly (via gearboxes and shafts), distributed propulsion is better suited to electric propulsion, where individual electric motors power, with or without gearboxes, propellers or fans.

The proposed embodiment therefore features eight variable speed electric motors connected to fixed pitch propellers for a simple and practical implementation of distributed electric propulsion.

To further enhance the safety of the aircraft, different motor technologies may be used when redundancy is implemented. For example, in an eight motors/thruster propulsion unit configuration, four motors may be permanent magnet (PM) rare earth motors (brushed or brushless) whereas the other four motors may be based on a different technology such as switch reluctance (SR) motors (not based on permanent magnets) to avoid common mode failures (for example demagnetisation of the permanent magnets due to excessive temperature) and allow for a safe, dissimilar system. As previously mentioned, this illustrated design can fly with only four propulsion units functioning and hence a common failure mode across one type of a set of 4 from the 8 propulsion units leaves the aircraft of the invention in flight. The preferred use of different propulsion unit technologies is in two sets of 4 units per technology.

FIG. 21 shows Example of Present invention with dissimilar motor technology. The example depicted in FIG. 21 feature a combination of permanent magnet (PM) and switched reluctance (SR) motors, with in this particular case PM motors connected to system S2 and SR motors connected to system S1:

### Power Sources

As discussed previously, although the proposed concept is compatible with traditional fossil fuels (e.g. kerosene, petrol, diesel, gas) engines (e.g. piston engines, turbines), the proposed aircraft is better suited to electric propulsion and therefore requires a source of electrical power (ideally, but not limited to, high voltage direct-current if using permanent magnet motors to reduce current and wire gauges).

The source of electrical power may be either batteries, fuel cells (for example hydrogen fuel cells) or a hybrid-power unit (for example an internal combustion engine coupled with an electric generator). Or a combination of more than one power source. For example, a hybrid-power unit may provide nominal power and emergency batteries may provide reserve power for non-nominal conditions.

The aircraft would ideally be modular and designed/certified to be compatible with various, interchangeable, sources of power. A dedicated space envelope could be allocated on the aircraft to the power source.

This space envelope/compartment could be fitted with a battery module for a fully electric aircraft with reduced range or customers could elect to purchase a hybrid power module that would fit within the dedicated space envelope and provide enhanced range for customers less concerned with emissions. Alternatively, a fuel cell module may be fitted for a cleaner more readily re-chargeable/re-filled alternative to batteries or hybrid-power unit.

Similarly, in the interest of safety, dissimilar battery technologies may be used between normal and emergency power sources when implementing a fully electric architecture. For example, lighter/smaller Lithium Ion batteries may be used for normal power and NiMH batteries (heavier/bigger) may be used for emergency power. The weight and space envelope penalty of NiMH batteries would be offset by the increased dissimilarity that would improve the safety of the aircraft and prevent common mode failures that may lead to both normal and emergency batteries to fail. An example of common mode failure could be in this case extreme temperatures (hot or cold) that are better tolerated by the NiMH batteries.

In the present invention when viewing the aircraft in its horizontal flight configuration provides a lateral view, from the side, fore being in the direction of flight and further forward in that direction than aft. The nose of the fuselage being fore in the aircraft.

In the present invention CW means clockwise and CCW counter clockwise.

I claim:

1. A tandem wing aircraft capable of vertical take-off and landing; the aircraft comprising: a fuselage pivoted between lateral arms of a yoke;
the arms of the yoke extending fore and aft and, at or towards the extremities of the arms:
the respective fore portions are linked laterally together by a fore aerofoil being a first of the tandem wings; and
the respective aft portions are linked laterally together by an aft aerofoil being a second of the tandem wings;
and at least one of the fore and aft aerofoils having mounted thereon one or more propulsion units.

2. The aircraft of claim 1 wherein the first and the second of the tandem wings are staggered.

3. The aircraft of claim 1 or claim 2 wherein the stagger is such that wings are fore and aft of the fuselage when viewing the aircraft in its horizontal flight configuration.

4. The aircraft of claim 2 or claim 3 wherein first and the second of the tandem wings are offset.

5. The aircraft of claim 4 wherein the first tandem wing is below the second tandem wing in the horizontal flight configuration.

6. The aircraft of any of claims 1 to 5 wherein the aerofoils are fixed wings in relation to the rest of the yoke and the yoke as a whole only moves with respect to the fuselage at the pivot.

7. The aircraft of any of claims 1 to 6 wherein the propulsion units are placed on both the first and the second of the tandem wings.

8. The aircraft of claim 3 wherein at least one the first and the second of the tandem wings has two propulsion units thereon, the propulsion units being placed respectively port and starboard.

9. The aircraft of claim 8 wherein the propulsion units are placed in equal numbers fore and aft of the aircraft.

10. The aircraft of any preceding claim wherein the aircraft comprises a flight control unit, the flight control unit controlling power to a distributed electric propulsion system of electric propulsion units driving fixed propellers on all propulsion units and the flight control unit are configured to manoeuvre the aircraft in one or more of pitch, roll and yaw by means of adjusting the relative propulsive force provided by the propulsion units.

11. The aircraft of claim 10 wherein the flight control unit is configured to manoeuvre the aircraft from a vertical take-off to a horizontal flight orientation by means of adjusting the relative propulsive force provided by the fore and aft propulsion units and from a horizontal flight to a vertical landing flight orientation.

12. The aircraft of claim 10 or claim 11 wherein the flight control unit is configured to manoeuvre the aircraft in all of pitch, roll and yaw by means of adjusting the relative propulsive force provided by the propulsion units.

13. The aircraft of claim 12 wherein, for the purposes of manoeuvring the aircraft in flight, the movable parts of the main body of the aircraft consist of the port and starboard pivots of the fuselage and the propulsion units.

14. The aircraft of any preceding claim were the rotation of the fuselage pivoted between lateral arms of a yoke is mediated so as to limit or enhance movement that would otherwise occur if the fuselage where freely rotatable with respect the yoke.

15. The aircraft of claim 13 wherein the mediation is by means of a braking arrangement and or actuator to drive rotation about the pivot.
